(19) United States
(12) Patent Application Publication
(10) Pub. No.: US 2026/0157489 A1
(43) Pub. Date: Jun. 11, 2026

(54) CASE FOR ELECTRONIC DEVICES AND RELATED ELECTRONIC DEVICE

(71) Applicant: LUXOTTICA S.R.L, Agordo (IT)

(72) Inventors: Gianluca CANDIOTTO, Castello Di Godego (IT); Dino MICHELON, Ponte Nelle Alpi (IT)

(21) Appl. No.: 18/845,354

(22) PCT Filed: Apr. 3, 2023
(86) PCT No.: PCT/IB2023/053362

§ 371 Date: Sep. 9, 2024

(51) Int. Cl. A45C 11/04; G02C 11/00; H02J 50/80

(52) U.S. Cl. CPC A45C 11/04; G02C 11/10; H02J 50/80

(57) ABSTRACT

A case for electronic devices, which comprises a case body adapted to accommodate an electronic device, and is provided with at least one receptacle for the electronic device, and a raised portion adapted to accommodate at least one charger, the raised portion being shaped complementarily to a portion of an electronic device and being configured to be paired with at least one complementary charger which is accommodated within the electronic device in the region of the electronic device that is adapted to make contact with the raised portion.

The present invention relates to a case for electronic devices, and a related electronic device. More specifically the invention relates to a case for electronic eyeglasses and to related electronic eyeglasses. Even more specifically, the invention relates to a case for electronic eyeglasses that enables the electronic eyeglasses to be charged when they are accommodated in the case.

As is known, electronic eyeglasses are increasingly widespread on the market. The term electronic eyeglasses means eyeglasses that are provided with various electronic functionalities, such as temperature sensors, video cameras and the like. Such electronic eyeglasses must obviously be charged before their use, in order to be able to take advantage of their electronic potential.

The charging of the eyeglasses occurs, generally, using a charging cable, or when they are placed in their case. In the conventional type of case used to charge eyeglasses, when the temple of the eyeglasses is in the folded position the eyeglasses can engage a charging system made up of pins and magnets which are arranged at at least one end of the eyeglasses case.

The pins and the magnets are combined so as to be able to position the eyeglasses so that the pins and the magnets come into contact with the part of the eyeglasses used for charging, which is located at the region of the frame or of the temple proximate to the hinge.

The eyeglasses substantially rest with the folded temple at the pins and magnets, in order to be able to effect the contact and start the charging process.

Charging systems are known in the state of the art in which an electronic connector arranged on the charging case engages or connects electronically with a corresponding connector arranged on the electronic eyeglasses. In some cases, such electronic connector comprises magnets or other mechanisms for retaining the electronic eyeglasses at a fixed receptacle, for the purpose of carrying out the charging and/or the transfer of data.

Charging systems are also known in the state of the art in which the charging interface is of the magnetic type and comprises two protruding circular magnets and two copper posts. The copper post is fixed to a spring so that the copper post can pass from a position of contact to a position of non-contact, thus making it possible for the copper posts to be completely in contact with the charging portion located on the temple.

Charging systems are also known in the state of the art in which the charging interface is of the wireless type, i.e. without the need for a connection with a fixed metallic element, and comprises wireless charging means positioned in the temple or in general in the frame of the eyeglasses.

However, the above solutions exhibit some drawbacks which are due to the fact that they do not offer an optimal mating or more generally an optimal contact between eyeglasses and case, and therefore they require an action by the user to properly position it so that it does not come away from the charging system or from the charging cable and/or in order to prevent unwanted disconnections, even if only temporary.

Furthermore, given that the eyeglasses are simply placed at the charging system located at one of the two mutually opposite ends of the case, it is necessary to immobilize the eyeglasses, for example at the nose pad and/or at the temples, in order to prevent them from moving around inside the case, thus negatively influencing the charging, given that it may happen that the eyeglasses lose contact with the pins and the magnets of the charging system.

Therefore, the solution offered by the known art does not ensure that the eyeglasses, once arranged even optimally in their case, can continue to be charged without problems, even if the user moves the case, carries it from one point to another, and in any case subjects it to knocks and jolts.

The aim of the present invention is to provide a case for electronic devices, and a related electronic device, which makes it possible to charge an electronic device contained in it, while ensuring that the device is placed precisely and firmly, without potential separations, inside the case.

Within this aim, an object of the present invention is to provide a case for electronic devices, and a related electronic device, in which the user does not need to take care to position the device manually and very accurately for it to be in the conditions for continuous and stable charging.

Another object of the present invention is to provide a case for electronic devices, and a related electronic device, that reduces to the minimum the action that the user needs to carry out in order to ensure that the device placed in the case is charged.

Another object of the present invention is to provide a case for electronic devices, and a related electronic device, that makes it possible to charge the electronic device in an absolutely efficacious manner.

Another object of the present invention is to provide a case for electronic devices that makes it possible for such devices to be charged without interruption even if they should be subjected to movements inside the case.

Another object of the present invention is to provide a case for electronic devices, and a related electronic device, that are highly reliable, easily and practically implemented and of low cost.

This aim and these and other objects are achieved by a case for electronic devices, which comprises a case body adapted to accommodate an electronic device, and is provided with at least one receptacle for the electronic device, characterized in that it comprises a raised portion adapted to accommodate at least one charging means, said raised portion being shaped complementarily to a portion of an electronic device and being configured to be paired with at least one complementary charging means which is accommodated within said electronic device in the region of said electronic device that is adapted to make contact with said raised portion.

Further characteristics and advantages of the invention will become more apparent from the detailed description of a preferred, but not exclusive, embodiment of the case for electronic devices, and related electronic device, according to the present invention, which is illustrated by way of non-limiting example in the accompanying drawings wherein:

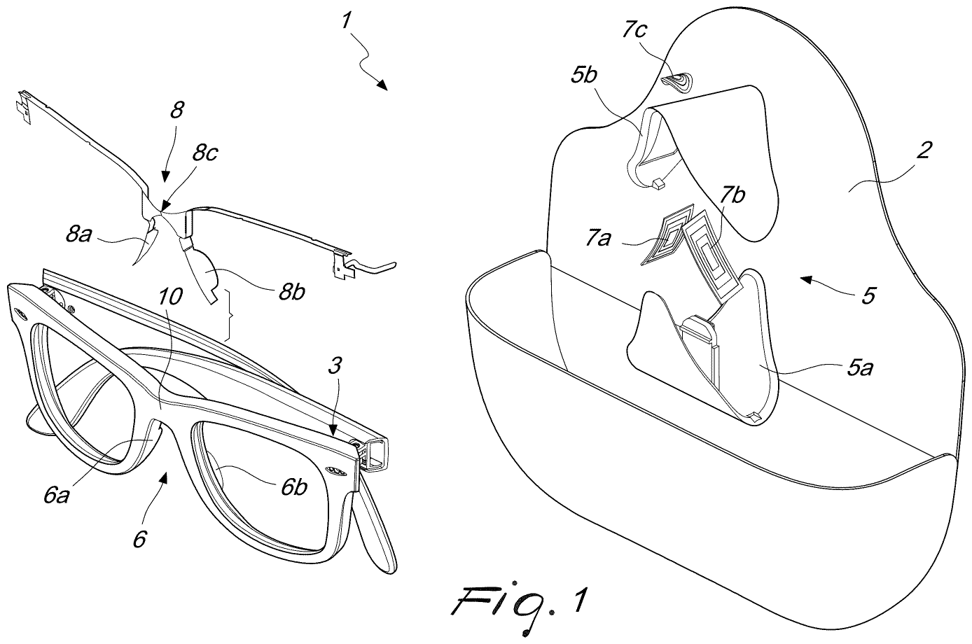

FIG. 1 is an exploded perspective view of the case for electronic devices according to the present invention and the related electronic device, in the form of a pair of electronic eyeglasses;

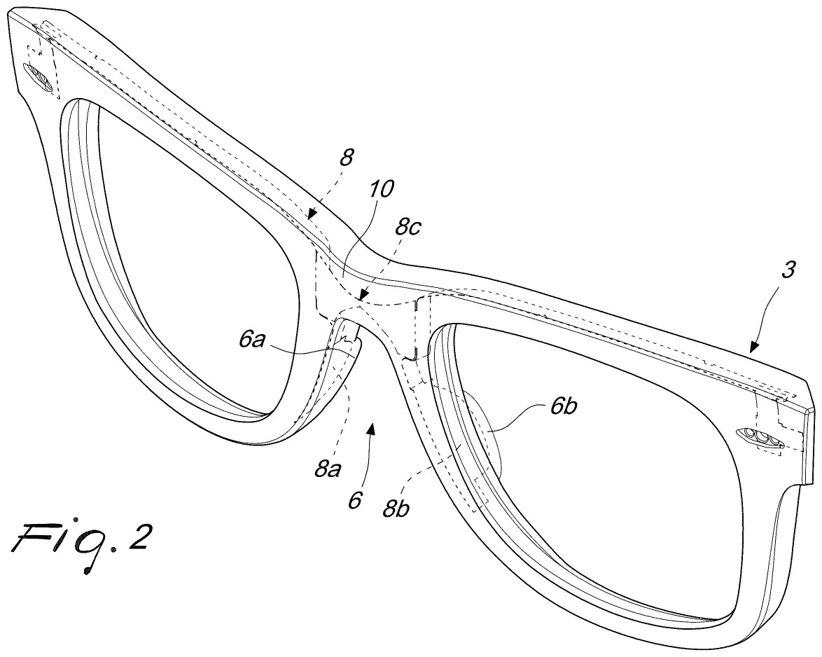

FIG. 2 is a perspective view of the electronic eyeglasses according to the invention, which are adapted to be accommodated in the case according to the present invention;

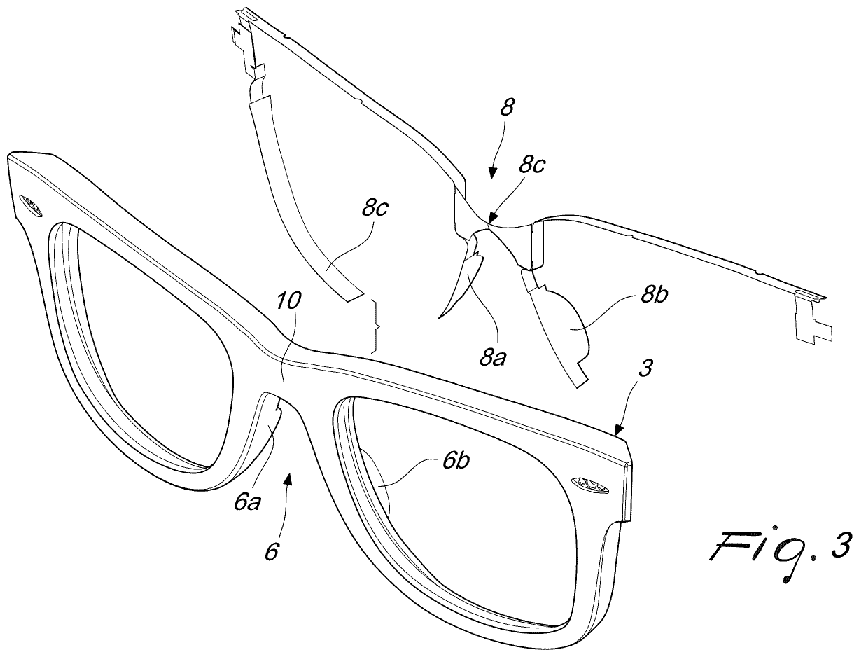

FIG. 3 is an exploded perspective view of the pair of electronic eyeglasses according to the present invention, in a second embodiment thereof;

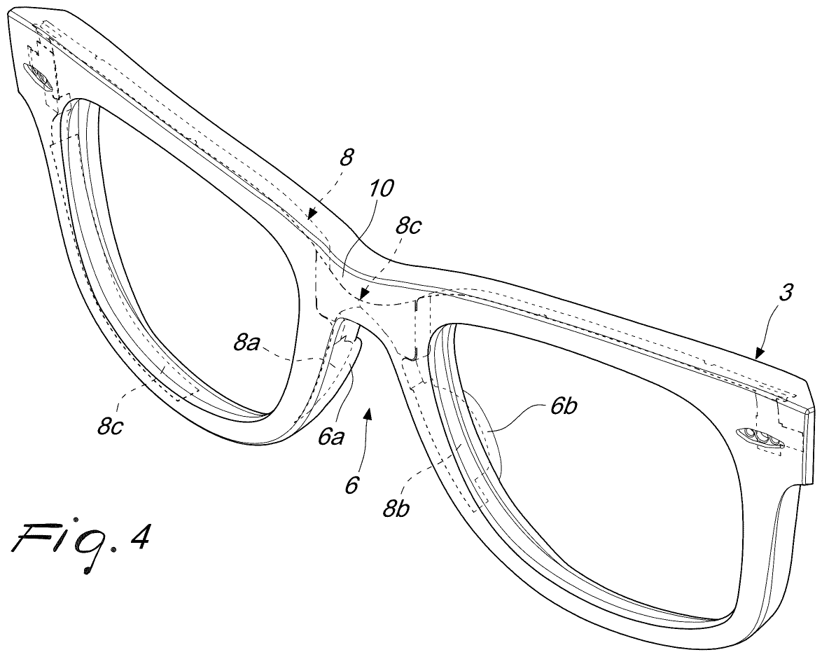

FIG. 4 is an exploded perspective view of the pair of electronic eyeglasses according to the present invention illustrated in FIG. 3;

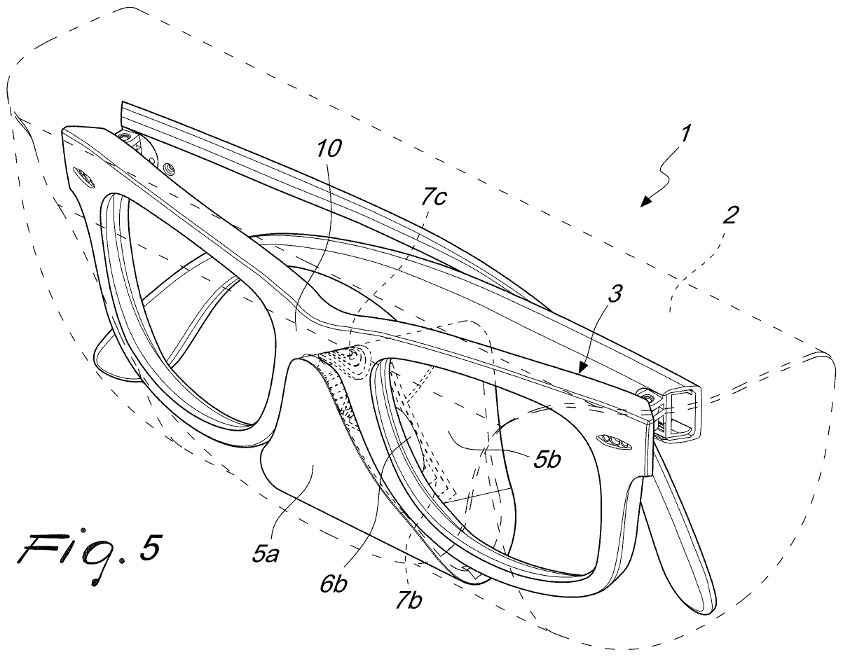

FIG. 5 is a transparent perspective view of the pair of electronic eyeglasses according to the present invention accommodated in the case according to the present invention;

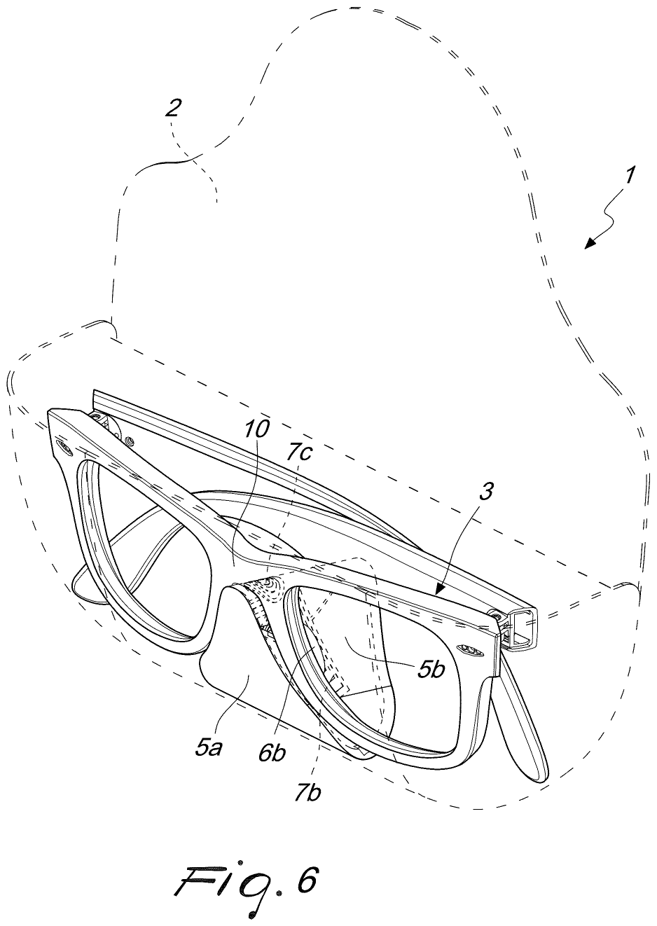

FIG. 6 is a transparent perspective view of the pair of electronic eyeglasses according to the present invention accommodated in the case according to the present invention, with the case open.

With reference to the figures, the case for electronic devices according to the present invention, generally designated by the reference numeral 1, comprises a case body 2 that is adapted to accommodate an electronic device 3, which for the purposes of example in the figures and in all of the description is a pair of electronic eyeglasses.

Conveniently, the case body 2 is defined by two half-shells joined together by way of a joining element such as a hinge, or is made of a single piece of covered material.

Conveniently, the body 2 has at least one recessed region which is adapted to accommodate the electronic device 3 and, if the electronic device is a pair of electronic eyeglasses 3, preferably two recessed regions, arranged mutually opposite, which are adapted to accommodate the lenses of the eyeglasses 3, and a raised portion 5 which can be adapted to the nose pad 6 of the eyeglasses 3, thus enabling a stable accommodation of the eyeglasses 3 in the case body 2.

Conveniently, the raised portion 5 is shaped so as to be perfectly adapted to the nose pad 6 of the pair of electronic eyeglasses 3.

Conveniently, the raised portion 5 is shaped so as to be perfectly adapted to the bridge of the pair of electronic eyeglasses 3.

More specifically, the raised portion 5 comprises a substantially triangular body constituted by a first portion 5a, directed upward, to which a second portion 5b is coupled, of similar shape and directed downward, covering the triangular first portion 5a.

The nose pad 6 of the pair of electronic eyeglasses 3 is adapted to be arranged astride the second portion 5b which substantially reproduces its shape.

The bridge 10 of the pair of electronic eyeglasses 3 is adapted to be arranged astride the second portion 5b which substantially reproduces its shape.

In this manner the pair of electronic eyeglasses 3 is accommodated in the case 1 and is arranged with the lenses substantially at right angles to the bottom of the case 1.

Advantageously, at least one charging means 7a, 7b, 7c, in particular antennas for transmitting energy and/or data, is positioned within the second portion 5b, and preferably a pair of charging means 7a, 7b arranged one on each side of the second portion 5b and/or a charging means 7c arranged at the top of the second portion 5b. The charging means 7a, 7b, 7c are configured to be arranged at at least one corresponding charging means 8a, 8b, 8c, preferably a pair of charging means 8a, 8b, in particular antennas for receiving energy and/or data, which are arranged within wings 6a, 6b of the nose pad 6 and/or a charging means 8c arranged at the bridge 10 of the eyeglasses 3.

By transmission or reception of energy, what is meant is a transfer of electric power from one element to another in order to charge the pair of electronic eyeglasses.

By transmission or reception of data is meant for example the charging status of the eyeglasses and/or other types of transmission/reception of data identifying the eyeglasses.

In a preferred embodiment, the at least one charging means 7a, 7b, in particular an energy transmission antenna, is arranged on only one side of the second portion 5b and engages the corresponding charging means 8a, 8b, in particular an energy reception antenna positioned within only one of the wings 6a, 6b of the nose pad 6.

In a preferred embodiment, the at least one charging means 7c, in particular an energy transmission antenna, is arranged at the top of the second portion 5b and engages the corresponding complementary charging means 8c, in particular an energy reception antenna positioned at the bridge 10. In an additional embodiment the charging means 7a, 7b, 7c and the corresponding charging means 8a, 8b, 8c are present simultaneously.

The charging means 7a, 7b, 8a, 8b are coils of conducting material and are part of a charge and control circuit.

The charge and control circuit comprises further elements such as, by way of non-limiting example, at least one electronic card, at least one battery, at least one USB connector and/or other electronic elements not shown in the figures.

The shape and the thickness of the charging means 7a, 7b, 8a, 8b may vary as a function of the position and of the accommodation in which they are located.

The charging means 8a, 8b are furthermore part of a flexible cable 8 which is arranged within the upper region of the front of the eyeglasses and extends at least to the wings 6a, 6b of the nose pad 3 and/or to the saddle region 6c of the front, i.e. to the region of the front that has an almost right-angle curvature. In particular, the flexible cable 8 extends to the region comprised between the endpiece of the eyeglasses, i.e. the part for connection between front and temple, up until the wings 6a, 6b of the nose pad 6. In an alternative embodiment the flexible cable 8 is in a single piece from the endpiece to the nose pad with no connection with the central part of the cable.

The flexible cable 8 serves to convey signals and/or data, for charging the eyeglasses and for defining capacitive zones that are adapted to allow manual touch, swiping with the fingers and the like on the part of the user in order to activate/deactivate functions of the pair of electronic eyeglasses.

Therefore, the user substantially places the pair of electronic eyeglasses 3 inside the case 1 to charge them, positioning the nose pad 6 and/or the bridge 10 astride the raised portion 5, so that the charging means 7a, 7b, 7c of the raised portion 5 are positioned proximate to the charging means 8a, 8b, 8c of the wings 6a, 6b of the nose pad 6 and/or of the bridge 10.

The charging means 7a, 7b, 7c and the complementary charging means 8a, 8b, 8c are wireless charging means.

The shape mating between the raised portion 5 and the nose pad 6 and/or the bridge 10 of the eyeglasses 3 makes it possible to keep the pair of electronic eyeglasses inside the case 1, so that the charging can take place without interruption and without the need for repositioning by the user.

In practice it has been found that the case for electronic devices, such as for example electronic eyeglasses and/or electrochromic eyeglasses, according to the invention, as well as the related electronic eyeglasses, fully achieve the intended aim and objects, in that the case makes it possible to stably and securely accommodate an electronic device such as a pair of electronic eyeglasses, without the user needing to perform any special actions to position the eyeglasses in the case.

The eyeglasses are held in position, in fact, simply by inserting the eyeglasses into the case body, placing the eyeglasses at the nose pad and/or the bridge, so that the eyeglasses remain inside the case, with the lenses arranged in a position substantially at right angles with respect to the bottom of the case body.

The case according to the present invention makes it possible to ensure the charging of the eyeglasses accommodated in it, by virtue of the fact that even if the eyeglasses should move inside the case the charging will not be interrupted because it is wireless.

In an alternative embodiment there are magnetic elements, magnets or parts made of magnetized metal, not shown in the figures, which are positioned both on the eyeglasses and on the raised portion 5 so as to enable an improved alignment between case and eyeglasses.

The case and the related electronic device, thus conceived, are susceptible of numerous modifications and variations, all of which are within the scope of the inventive concept.

Moreover, all the details may be substituted by other, technically equivalent elements.

In practice, the materials used, as well as the contingent shapes and dimensions, may be any according to the requirements and to the state of the art.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1-16. (canceled)

17. A case for electronic devices, which comprises a case body adapted to accommodate an electronic device, and is provided with at least one receptacle for the electronic device, and further comprising a raised portion adapted to accommodate at least one charging means, said raised portion being shaped complementarily to a portion of the electronic device and being configured to be paired with at least one complementary charging means which is accommodated within said electronic device in the region of said electronic device that is adapted to make contact with said raised portion.

18. The case according to claim 17, wherein said electronic device is a pair of electronic eyeglasses and said portion of the electronic device is a nose pad of said pair of electronic eyeglasses.

19. The case according to claim 17, wherein said electronic device is a pair of electronic eyeglasses and said portion of the electronic device is a bridge of said pair of electronic eyeglasses.

20. The case according to claim 17, wherein said electronic device is a pair of electronic eyeglasses and said portion of the electronic device is a nose pad and a bridge of said electronic eyeglasses.

21. The case according to claim 17, wherein said at least one charging means and said at least one complementary charging means are wireless charging means.

22. The case according to claim 20, wherein said at least one complementary charging means of said pair of electronic eyeglasses is arranged within at least one of wings of the nose pad of said pair of electronic eyeglasses and/or at the bridge.

23. The case according to claim 17, comprising a pair of charging means and/or an additional charging means and a pair of complementary charging means and/or an additional complementary charging means.

24. The case according to claim 23, wherein said raised portion comprises a first, lower portion adapted to be coupled to a second, upper portion, said charging means being each arranged proximate to a lateral surface of the upper portion of the raised portion.

25. The case according to claim 24, wherein said additional charging means is arranged at a top of said second, upper portion.

26. The case according to claim 22, wherein said complementary charging means of said pair of electronic eyeglasses are part of a flexible cable which is arranged within an upper region of a front of the eyeglasses and extends at least to the wings of the nose pad and/or to a saddle region of the front.

27. The case according to claim 17, wherein said charging means of said raised portion comprise antennas for transmitting energy and/or data.

28. The case according to claim 22, wherein said complementary charging means of said nose pad comprise antennas for receiving energy and/or data.

29. The case according to claim 22, wherein said complementary charging means of said bridge comprise at least one antenna for receiving energy and/or data.

30. A pair of electronic eyeglasses, comprising a front with a nose pad and respective wings, and a pair of temples, wherein it comprises at least one charging means which is arranged within said wings and/or a charging means arranged at the bridge, said at least one charging means being configured to be paired with at least one charging means which is arranged within a raised portion of a case.

31. The pair of electronic eyeglasses according to claim 30, wherein said nose pad is shaped complementarily to said raised portion of said case.

32. The pair of electronic eyeglasses according to claim 30, wherein said at least one charging means of said pair of electronic eyeglasses is part of a flexible cable which is arranged within the upper region of the front of the eyeglasses and extends at least to the wings of the nose pad and/or to a saddle region of the front.
